(19) United States
(12) Patent Application Publication
(10) Pub. No.: US 2012/0099242 A1
(43) Pub. Date: Apr. 26, 2012

(54) CAPACITOR ELECTRODE BODY, METHOD FOR MANUFACTURING THE CAPACITOR ELECTRODE BODY, CAPACITOR, AND METHOD FOR MANUFACTURING THE CAPACITOR

(75) Inventors: Tatsushi Ohyama, Moriguchi-shi (JP); Hideaki Fujiwara, Osaka (JP); Kenji Fukase, Osaka (JP)

(73) Assignee: Sanyo Electric Co., Ltd., Moriguchi-shi (JP)

(21) Appl. No.: 13/318,075

(22) PCT Filed: Apr. 22, 2010
(86) PCT No.: PCT/JP10/02936

§ 371 Date: Jan. 13, 2012

(30) Foreign Application Priority Data
Apr. 28, 2009 (JP) 2009-109507
May 29, 2009 (JP) 2009-130786

(51) Int. Cl. H01G 4/005; H01G 13/00; H01M 4/00

(52) U.S. Cl. 361/303; 29/885; 29/25.03

(57) ABSTRACT

An anode body includes an anode substrate, made of at least one of a valve metal and its alloy, and a porous layer, disposed on the anode substrate, which is formed of a combination of a plurality of second particles each composed of first metal particles. The porous layer includes a diffusely packed region X, formed within the secondary particles, and a closely packed region Y, formed between the anode substrate and the secondary particles and between the respective secondary particles. The closely packed region Y has a lower porosity than that of the diffusely packed region X.

### CROSS-REFERENCE TO RELATED APPLICATION

The present application is a national phase application of PCT Application No. PCT/JP2010/002936, filed on Apr. 22, 2010, and claims priority to Japanese Application No. 2009-130786, filed on May 29, 2009, and Japanese Application No. 2009-109507, filed on Apr. 28, 2009, the entire contents of which are herein incorporated by reference.

### TECHNICAL FIELD

The present invention relates to a capacitor electrode body, a method for manufacturing the capacitor electrode body, a capacitor, and a method for manufacturing the capacitor.

### BACKGROUND TECHNOLOGY

Along with the on-going downsizing and sophistication of performance of electronic hardware, representative of which being personal computers (PCs) and mobile phones, there are yearly increasing demands for smaller, higher-speed, and higher-integrated electronic circuitry to be mounted in those electronic hardware. The same is true for the passive components constituting the electronic circuitry. For example, the demand for capacitors is for ones as thin as practicable, but of larger capacity.

Disclosed in Patent Document 1 and Non-patent Document 1 are the methods of manufacturing capacitors with large capacitance per unit volume.

More specifically, in the manufacturing method of an electrolytic capacitor disclosed in Patent Document 1, a porous anode body is formed by firing the pressed powders of a valve metal, such as aluminum (Al), tantalum (Ta), niobium (Nb), and titanium (Ti), which allows anodic oxidation with rectifying action.

Also, in the manufacturing method of an electrolytic capacitor disclosed in Non-patent Document 1, a porous anode body is formed by first forming a Ta—Cu alloy film by simultaneously sputtering tantalum (Ta) and copper (Cu), causing a grain growth in the film material by vacuum heat treatment at predetermined temperatures, and then selectively dissolving Cu with nitric acid.

### RELATED ART DOCUMENTS

### Patent Documents

[Patent Document 1] Japanese Unexamined Patent Publication No. 2003-257787.

[Non-patent Document 1] Tetsufumi Komukai, Toshiyuki. Osako (Ichikawa Research Laboratory, Sumitomo Metal Mining Co., Ltd.) “Preparation of porous tantalum foil and their anodic properties as a capacitor”, Abstracts of the 73rd Meeting of the Electrochemical Society of Japan.

### DISCLOSURE OF THE INVENTION

### Problems to be Solved by the Invention

According to the methods for manufacturing electrolytic capacitors as disclosed in Patent Document 1 and Non-patent Document 1, a large number of voids are formed in the anode body so as to enlarge the surface area of the anode body. As a result, electrical connection between the metal particles is impeded because of the voids, which leads to the problem of difficulty of electric currents flowing in the anode body and the consequently larger resistance of the anode body. In other words, with the conventional electrolytic capacitor, it is difficult to have low ESR (equivalent series resistance) while retaining an adequate surface area for the anode body.

The present invention has been made in view of these problems, and a purpose thereof is to provide a technology that can further lower the ESR of the capacitor while retaining an adequate surface area for the anode body.

### Means for Solving the Problems

A capacitor electrode body according to an embodiment of the present invention includes: a substrate made of at least one of a valve metal and an alloy thereof; and a porous layer disposed on the substrate, the porous layer being formed of a combination of a plurality of first metal particles composed of at least one of the valve metal and the alloy thereof, wherein the porous layer includes a first region and a second region, the second region being so formed as to surround the first region and having a lower porosity than the first region.

A capacitor according to another embodiment of the present invention includes: an anode body comprising the above-described capacitor electrode body; an dielectric layer formed on a surface of the anode body; and a cathode body formed such that the cathode body covers the surface of the dielectric layer.

A method, for manufacturing a capacitor electrode body, according to still another embodiment of the present invention includes a porous layer manufacturing process of forming a porous layer by spraying secondary particles composed of first metal particles made of at least one of a valve metal and an alloy thereof onto a substrate made of at least one of a valve metal and an alloy thereof in a manner such that a first region and a second region are formed, the second region being so formed as to surround the first region and having a lower porosity than the first region.

A method, for manufacturing a capacitor electrode body, according to still another embodiment of the present invention includes: a process of preparing a capacitor electrode body, formed by employing the above-described manufacturing method, as an anode body; a dielectric layer forming process of forming a dielectric layer by oxidizing a surface of the anode body; and a cathode body forming process of forming a cathode body in such a manner as to cover a surface of the dielectric layer.

A method, for manufacturing a capacitor electrode body, according to still another embodiment of the present invention includes: a first process of forming a composite body by spraying first metal particles made of at least one of a valve metal and an alloy thereof and second metal particles, which are preferentially removed over the first metal particles through a predetermined processing, onto a substrate made of at least one of a valve metal and an alloy thereof in a manner such that a first void has void in between each particle; and a second process of removing the second metal particles from the composite body through the predetermined processing.

A method, for manufacturing a capacitor electrode body, according to still another embodiment of the present invention includes: a process of preparing a capacitor electrode body, formed by employing any of the above-described manufacturing method, as an anode body; a dielectric layer forming process of forming a dielectric layer by oxidizing a surface of the anode body; and a cathode body forming process of forming a cathode body in such a manner as to cover a surface of the dielectric layer.

### Effect of the Invention

The present invention further lowers the ESR of the capacitor while retaining an adequate surface area for the anode body. Also, the present invention provides a capacitor anode and a capacitor achieving a larger capacitance of the capacitor.

### BRIEF DESCRIPTION OF THE DRAWINGS

FIG. 1A is a schematic cross-sectional view for explaining the structure of a capacitor according to a first embodiment of the present invention.

FIG. 1B is an enlarged illustration of a region enclosed by a broken line in FIG. 1A.

FIGS. 2A and 2B are cross-sectional views for explaining a method for manufacturing an anode body of the capacitor.

FIG. 3 is a schematic diagram of a cold spray apparatus used in a first embodiment.

FIGS. 4A to 4C are cross-sectional views for explaining a method for manufacturing a cathode body of the capacitor.

FIG. 5 is an SEM (scanning electron microscope) photo of a porous layer formed using a cold spray apparatus.

FIG. 6 is the enlargements of parts of the SEM photo of FIG. 5.

FIG. 7A is a schematic cross-sectional view for explaining the structure of a capacitor according to a second embodiment of the present invention.

FIG. 7B is an enlarged illustration of a region enclosed by a broken line in FIG. 7A.

FIGS. 8A to 8C are cross-sectional views for explaining a method for manufacturing an anode body of the capacitor.

FIG. 9 is a schematic diagram of a cold spray apparatus used in a second embodiment.

FIG. 10 is a schematic cross-sectional view showing the structure of a capacitor manufactured by employing a method, for manufacturing the capacitor, according to a third embodiment of the present invention.

FIGS. 11A to 11C are cross-sectional views for explaining a method for manufacturing an anode body of the capacitor.

FIGS. 12A to 12C are cross-sectional views for explaining a method for manufacturing a cathode body of the capacitor.

### BEST MODE FOR CARRYING OUT THE INVENTION

Hereinafter, the present invention will be described based on preferred embodiments with reference to the accompanying drawings. The same or equivalent constituents, members, processes illustrated in each drawing will be denoted with the same reference numerals, and the repeated description thereof will be omitted as appropriate. The size of components in each Figure may be changed as appropriate in order to aid understanding. The embodiments do not intend to limit the present invention but exemplify the invention. All of the features and the combinations thereof described in the embodiments are not necessarily essential to the invention.

### First Embodiment

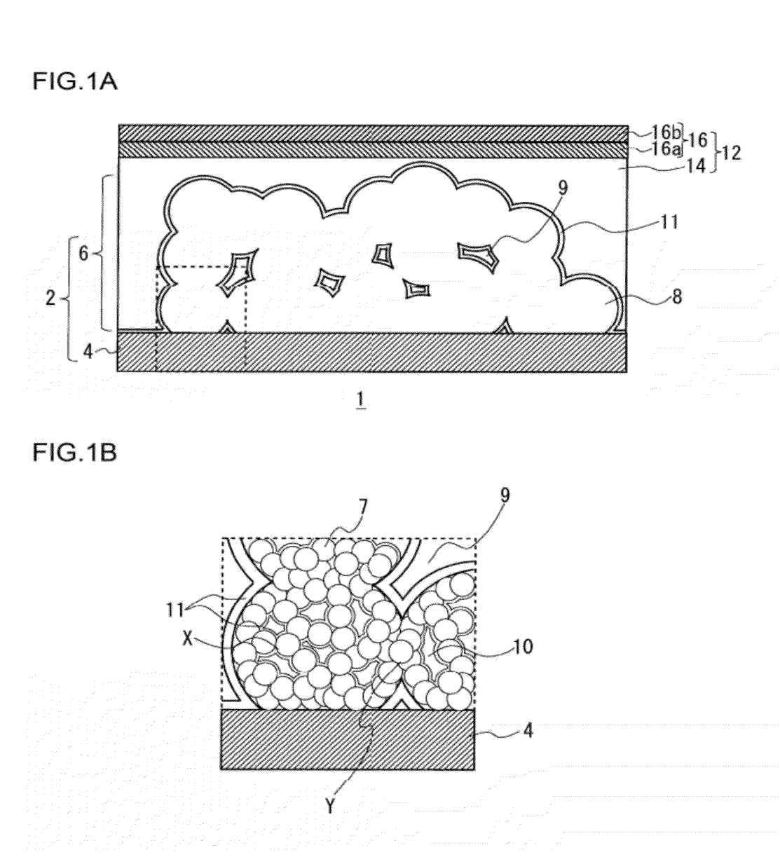

A description will now be given of a structure of a capacitor 1 and a method for manufacturing the capacitor 1 according to a first embodiment of the present invention, with reference to FIGS. 1A to 4C.

### Structure of a Capacitor 1

FIG. 1A is a schematic cross-sectional view for explaining the structure of the capacitor 1, and FIG. 1B is an enlarged illustration of the region enclosed by a broken line in FIG. 1A.

The capacitor 1 includes an anode body 2, a dielectric layer 11 formed on the surface of the anode body 2, and a cathode body 12 formed on the opposite side of the anode body 2 with the dielectric layer 11 disposed between the dielectric layer 11 and the anode body 2.

The anode body 2 includes an anode substrate 4 (equivalent to a substrate of the present invention), made of at least one of a valve metal and an alloy thereof, and a porous layer 6 disposed on the anode substrate 4.

The porous layer 6 is a layer formed of a combination of a plurality of secondary particles 8 composed of first metal particles 7 which comprise at least one of the valve metal and the alloy thereof. Voids 9, each measuring about 0.01 μm to about 1 μm, are formed amidst the secondary particles 8. These voids 9 are created in a manner dependent on the shapes and sizes of the secondary particles 8 in contact with one another. The porous layer 6 is about 500 μm thick, for instance.

The secondary particles 8, as shown in FIG. 1B, are each a porous aggregate measuring about 10 μm to about 100 μm in diameter, which is formed by assembling a plurality of the first metal particles 7 each measuring about 1 μm or less in diameter. Formed within a secondary particle 8 are voids 10, whose size is about 0.01 μm to about 1 μm, amongst the first metal particles 7. These voids 10 are created in a manner dependent on the shapes and sizes of the first metal particles 7 in contact with one another. In other words, diffusely packed regions X, having high voidage, are formed within the secondary particle 8. Also, closely packed regions Y, having voidage lower than that of the diffusely packed regions X, are formed between the anode substrate 4 and the secondary particle 8 and between the secondary particles 8 themselves.

The anode substrate 4 is a plate-shaped member made of at least one of a valve metal and an alloy thereof. The anode substrate 4 includes a thin film (foil) and lead wire, and an anode terminal (not shown) for external connection is coupled thereto. Also, included in parts of the anode substrate 4 are pluralities of the first metal particles 7 combined to form film-like structures. The anode substrate 4, when it is a thin film of metal, is about 100 μm thick, for instance.

It is to be noted that the valve metal as used herein is a metal capable of forming on the surface thereof a dielectric oxide film, which is extremely closely packed and durable, through electrolytic oxidation (anodic oxidation) or the like. The valve metals that can be cited include tantalum (Ta), niobium (Nb), titanium (Ti), and aluminum (Al). Also, the alloys of the valve metal that can be cited include the alloys of the above-mentioned valve metals themselves or the alloys of the above-mentioned valve metals and the other metals. In the present embodiment, Ta is used as the metal constituting the anode substrate 4 and the first metal particles 7. Note that the anode substrate 4 and the first metal particles 7 may be made of metals different from each other.

The dielectric layer 11, which is an oxide film formed on the surface of the anodic body 2, is formed by an electrolytic formation process, for instance. The dielectric layer 11 is formed on the surfaces where the anode substrate 4 and the porous layer 6 are exposed, that is, in the regions other than those where the first metal particles 7 are in contact with one another and those where the first metal particles 7 are in contact with the anode substrate 4.

The cathode body 12 includes a conductive polymer layer 14 and a cathode substrate 16 stacked on the conductive polymer layer 14.

The conductive polymer layer 14 is formed in a predetermined thickness in such a manner as to cover the surface of the dielectric layer 11, that is, to bury the voids 9 and the voids 10 of the anode body 2. Note here that in the diffusely packed regions X of the porous layer 6, the conductive polymer layer 14 is formed in such a manner as to wrap around the voids 10. Also, there is little conductive polymer layer 14 formed in the closely packed regions Y having voidage lower than that in the diffusely packed regions X. While there is no particular limitation on the conductive polymer layer 14 as long as it contains some conductive polymer material, the conductive polymer layer 14 preferably used may contain a conductive polymer, such as polythiophene, polypyrrole, or polyaniline, or such material as TCNQ (7,7,8,8-tetracyanoquinodimethane) complex salt.

The cathode substrate 16 is composed, for instance, of a carbon paste layer 16a, which is stacked on the conductive polymer layer 14, and a silver paste layer 16b, which is stacked on the carbon paste layer 16a. Coupled to the cathode substrate 16 is a cathode terminal (not shown) for external connection.

### Method for Manufacturing a Capacitor 1

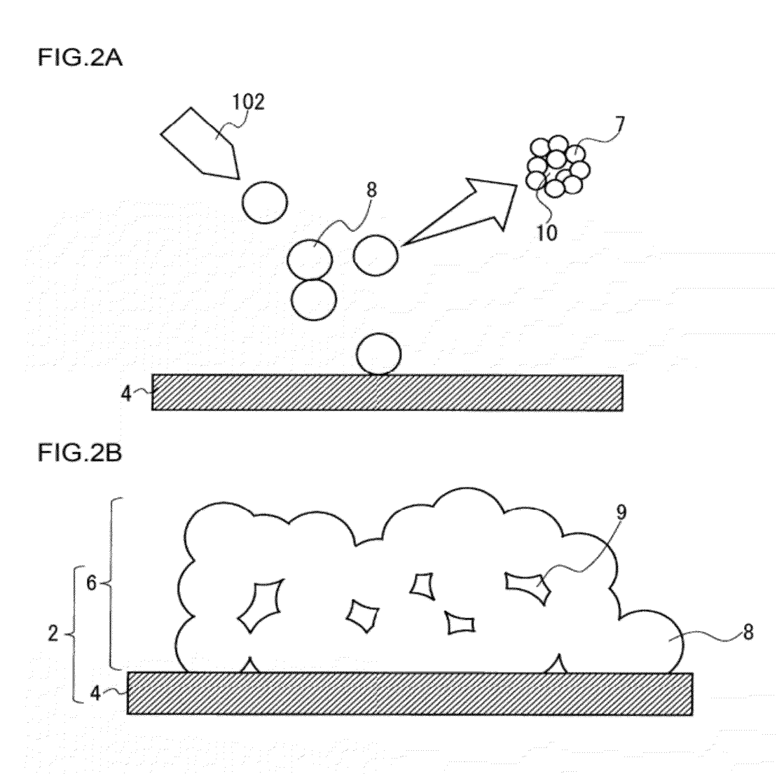

Next, a description will be given of a method for manufacturing a capacitor 1 with reference to FIGS. 2A to 4C. FIGS. 2A and 2B are cross-sectional views for explaining a method for manufacturing an anode body of the capacitor 1.

As shown in FIG. 2A, secondary particles 8, each made up of first metal particles 7 which are Ta, are sprayed onto the surface of the anode substrate 4 which is a foil of valve metal Ta. Formed within the secondary particle 8 are diffusely packed regions X, having high voidage, which contain voids 10 formed among the first metal particles 7.

As shown in FIG. 2B, the secondary particles 8 sprayed onto the anode substrate 4, if they hit the anode substrate 4, attach themselves to the surface of the anode substrate 4. Also, those secondary particles 8 hitting the secondary particles 8 already attaching to the anode substrate 4 combine themselves with the secondary particles 8 there to form metal particle clumps. As a result, a porous layer 6, which is constituted by secondary particles 8, is formed on the surface of the anode substrate 4. Retained in the porous layer 6 are voids 10 within each of the secondary particles 8 which have been sprayed onto the anode substrate 4.

At this time, the closely packed regions Y of low voidage, in which the first metal particles 7 making up each of the secondary particles 8 are in close contact with one another, are created between the anode substrate 4 and the secondary particles 8 and between the secondary particles 8 themselves by the forces that occur at the collisions of the secondary particles 8. Accordingly, the voidage of the closely packed regions Y becomes lower than the voidage of the diffusely packed regions X formed amidst the secondary particles 8.

Here, a cold spray method is used preferably as a method for spraying secondary particles 8 onto the anode substrate 4. The cold spray method is a technique of coating an object in which material particles or powder is sprayed onto the surface of objects to be coated in streams of predetermined high temperature and high speed and then deposited on the surface thereof.

The cold spray method is characterized in that the temperature of the material particles when sprayed is lower than the melting point and softening point thereof and the speed of the stream is very high, namely, sonic to supersonic speed. Also, the material particles sprayed by the cold spray method, which directly form a solid film without melting, are less prone to deterioration due to oxidation or heat.

Therefore, when the cold spray method is used, a porous layer 6 which has high adhesion strength between the anode substrate 4 and the secondary particles 8 and between the secondary particles 8 themselves can be formed.

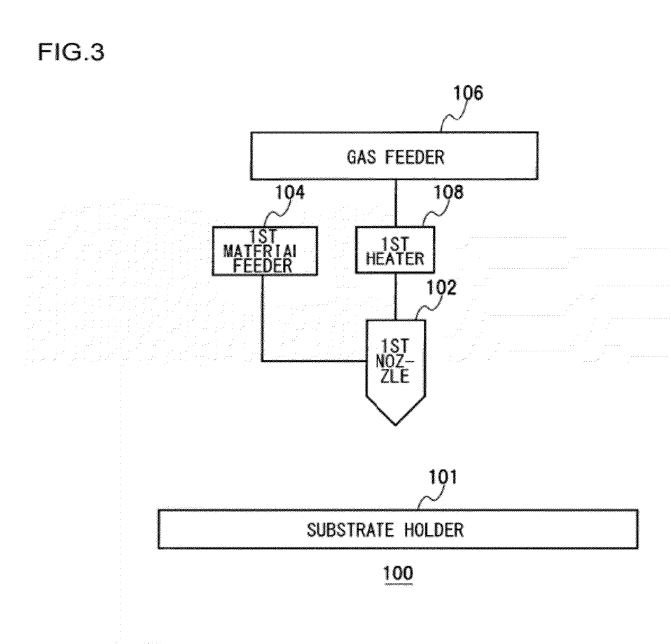

FIG. 3 is a schematic diagram of a cold spray apparatus 100. The cold spray apparatus 100 includes a substrate holder 101, a first nozzle 102, a first material feeder 104, a gas feeder 106, and a first heater 108. The cold spray apparatus 100 is installed in the air.

The substrate holder 101 holds the anode substrate 4 and can move the anode substrate 4 relative to the first nozzle 102 while heating the anode substrate 4.

The first material feeder 104 feeds secondary particles 8 to the first nozzle 102. The gas feeder 106 feeds a pressurized gas to the first nozzle 102 via the first heater 108. The gas sent out to the first nozzle 102 from the gas feeder 106 is heated by the first heater 108 before the gas is sent to the first nozzle 102. The secondary particles 8 fed to the first nozzle 102 are sprayed from the first nozzle 102 under the pressure of the gas fed from the gas feeder 106.

By the use of the cold spray apparatus 100, the anode substrate 4 can be moved relative to the first nozzle 102 by the substrate holder 101 while the secondary particles 8 are sprayed onto the anode substrate 4 from the first nozzle 102. Thus, the secondary particles 8 can be sprayed onto the entire surface of a predetermined region of the anode substrate 4.

It is understood that the voidage (porosity) of the porous layer 6 can be adjusted by making adjustments to the sizes of first metal particles 7 and secondary particles 8, the spray speed (sprayed gas pressure) from the first nozzle 102, the sprayed gas temperature, and the like. For example, the choice of smaller sizes for the first metal particles 7 and secondary particles 8 and lower spray speed of the particles will create a porous layer 6 of greater porosity. Also, the choice of a lower sprayed gas temperature may create a porous layer 6 of greater porosity.

In the present embodiment, the voidage of the porous layer 6 is calculated by a mercury intrusion technique using a mercury porosimeter. More specifically, a vessel containing an anode body 2 is evacuated, and then the vessel is filled with mercury. Mercury has the property of not wetting material objects, and therefore mercury, as it is, will not enter into the fine pores of the porous layer 6. However, if pressure is applied to the mercury and the pressure is increased, then the mercury will enter into larger pores first and then smaller pores of the porous layer 6. In this manner, the sizes and volumes of the fine pores of the porous layer 6 are measured, and the voidage of the porous layer 6 is calculated.

Also, the voidage of the porous layer 6 can be calculated using a sectional image or the like of the porous layer 6 captured by a transmission electron microscope (TEM) or the like. For example, a region containing about 100 pieces of secondary particles 8 is defined, and the voidage of the porous layer 6 can be calculated from the area ratio between the part of the secondary particles 8 including the dielectric layers 11 of the defined region and the other part thereof, namely, the voids 9 and the voids 10 (the part of the conductive polymer layer 14 of a completed capacitor 1).

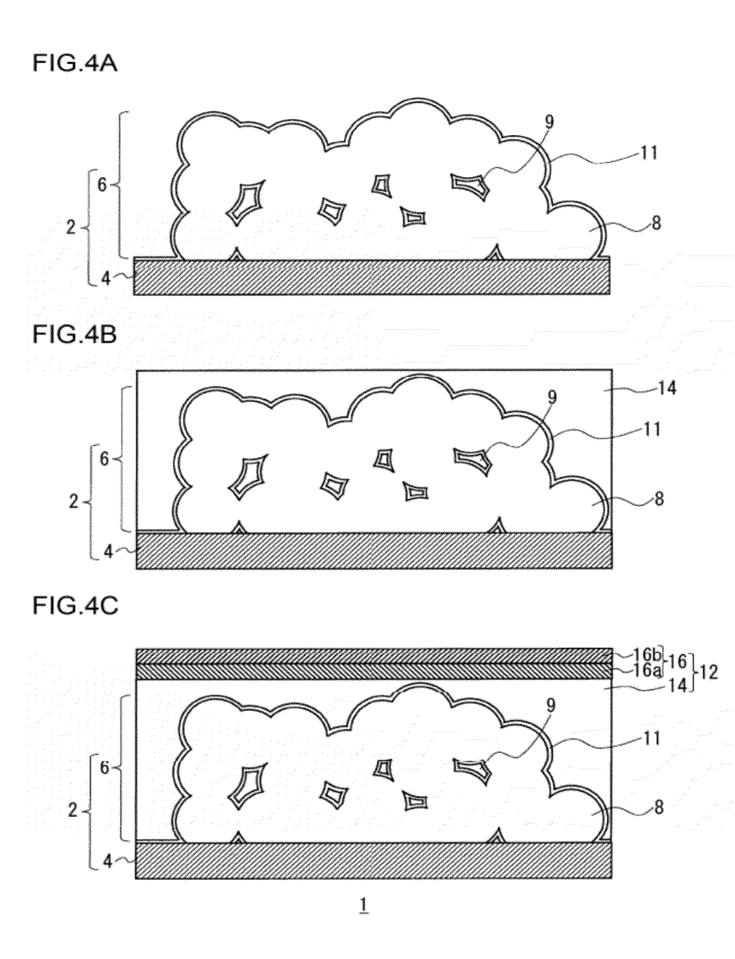

Next, a description will be given of a method for manufacturing a dielectric body and a cathode body of the capacitor 1 with reference to FIGS. 4A to 4C. FIGS. 4A to 4C are cross-sectional views for explaining a method for manufacturing a cathode body of the capacitor 1.

As shown in FIG. 4A, a dielectric layer 11 is formed by oxidizing the surface of an anode body 2. Since the anode substrate 4 and the first metal particles 7 are made of Ta, the dielectric layer 11 is an oxide film composed of tantalum oxide (Ta₂O₅). In the present embodiment, the dielectric layer 11 is formed by performing the electrolytic formation process on the anode body 2. More specifically, the anode body 2 is subjected to an anodic oxidation at constant voltage in an electrolyte of 0.01 to 1.0 mass % phosphoric acid aqueous solution, thereby forming an oxide film of tantalum oxide on the surface thereof. Thus, the dielectric layer 11 is formed on the exposed surfaces of the anode substrate 4 and the porous layer 6, that is, in the regions other than the region where the first metal particles 7 are in contact with one another and the region where the first metal particles 7 are in contact with the anode substrate 4.

Then, as shown in FIG. 4B, a conductive polymer layer 14 is formed by a chemical oxidative polymerization in such a manner as to cover the surface of the dielectric layer 11, that is, to bury the voids 9 and the voids 10 in the anode body 2. More specifically, the conductive polymer layer 14 is formed by first immersing the anode body 2 in a chemical polymerization liquid comprised of 3,4-ethylenedioxythiophene, iron(III) p-toluenesulfonate, and 1-butanol and then forming a polythiophene layer on the dielectric layer 11 by a heat treatment in the air. The immersion of the anode body 2 in the chemical polymerization liquid and the heat treatment process are repeated a plural number of times.

Through this process, the chemical polymerization liquid penetrates into the diffusely packed regions X of the porous layer 6, which have high voidage, and the conductive polymer layer 14 is formed in such a manner that the conductive polymer layer 14 wraps closely around or sneaks in close to the anode body 2. In contrast to this, the conductive polymer layer 14 is scarcely formed in the closely packed regions Y, which have low voidage and thus do not allow the penetration of the chemical polymerization liquid.

Next, as shown in FIG. 4C, a carbon paste layer 16a and a silver paste layer 16b, in this order, are stacked on top of the conductive polymer layer 14, thereby forming a cathode substrate 16. In this manner, a cathode body 12, which includes the conductive polymer layer 14 and the cathode substrate 16, is formed.

Then a capacitor 1 can be fabricated by coupling an anode terminal (not shown) to the anode substrate 4 via a conductive adhesive, for instance, and coupling a cathode terminal (not shown) to the cathode substrate 16 via a conductive adhesive, for instance.

In summing up the operation and the effect of the structure described above, the capacitor 1 according to the present embodiment is provided with a porous layer 6 which has diffusely packed regions X formed within the secondary particle 8 and closely packed regions Y, having voidage lower than that of the diffusely packed regions X, formed between the anode substrate 4 and the secondary particle 8 and between the secondary particles 8 themselves.

Therefore, the capacitor 1, which has the diffusely packed regions X having high voidage and formed within the secondary particle 8, can provide capacitance with little decrease in the surface area per unit volume of the anode body 2.

Also, there is difference in voidage between the diffusely packed regions X and the closely packed regions Y. Thus, in the formation of the conductive polymer layer 14, some of the conductive polymer layer 14 wraps therearound or sneaks in to be formed within the diffusely packed regions X having high voidage and little of the conductive polymer layer 14 is formed within the closely packed regions Y having low voidage. Thus, part of the conductive polymer layer 14 wraps therearound or sneaks in to be formed within the diffusely packed regions X. This enables the volume of the conductive polymer layer 14 within the anode body 2 to be increased and enables the resistance of the cathode body 12 within the anode body 2 to be reduced. Also, since little of the conductive polymer layer 14 is formed in the closely packed regions Y, the electrical connection between the first metal particles 7 constituting the anode body 2 can be improved and the resistance of the anode body 2 can be reduced.

In particular, the formation of a closely packed region Y between the secondary particles 8 results in the formation of a region where the resistance is low within the porous layer 6. This provides an excellent advantage of coexistence of large capacitance of the capacitor and low resistance of the anode body 2. Also, the formation of a closely packed region Y between the anode substrate 4 and the porous layer 6 allows the contact area between the anode substrate 4 and the porous layer 6 to be increased and the resistance of the anode body 2 to be further reduced.

Accordingly, the capacitor 1 in the present embodiment, in contrast to the conventional electrolytic capacitor, can reduce the resistance of the anode body 2 and the cathode body 12 while retaining an adequate surface area for the anode body 2. Thus, the ESR of the capacitor 1 can be lowered.

Note here that, to derive the above-mentioned advantage, the voidage in the diffusely packed regions X is preferably about 50% to about 80% and more preferably about 60% to about 70%. Also, the voidage in the closely packed regions Y is preferably about 20% to about 40% and more preferably about 25% to about 35%.

Also, according to the present embodiment, it is not necessary to perform a firing or other heat treatment processes after the formation of the porous layer 6, unlike the method disclosed in Patent Document 1. Thus, the voids 9 and voids 10 in the porous layer 6 can be prevented from getting smaller in size (diameter) on account of the heat treatment process. As a result, the present embodiment can prevent the reduction in the area of the anode body 2 in contact with the conductive polymer layer 14 through the dielectric layer 11 and in the volume of the conductive polymer layer 14 wrapping around or sneaking into the anode body 2. And this will not only raise the capacitance derivation rate but also realize lowered ESR for the capacitor 1.

### Example of Observation of Porous Layer

A porous layer was actually produced according to the above-described method of manufacturing the capacitor 1 and was subjected to an observation. More specifically, the secondary particles of the first metal particles made of Ta were sprayed onto an anode substrate made of Ta foil, using a cold spray apparatus 100 as shown in FIG. 3. When the secondary particles were sprayed onto the anode substrate, the heating temperature of the anode substrate was 25° C., and the sprayed gas pressure and the sprayed gas temperature of the secondary particles were 1 MPa and 500° C., respectively.

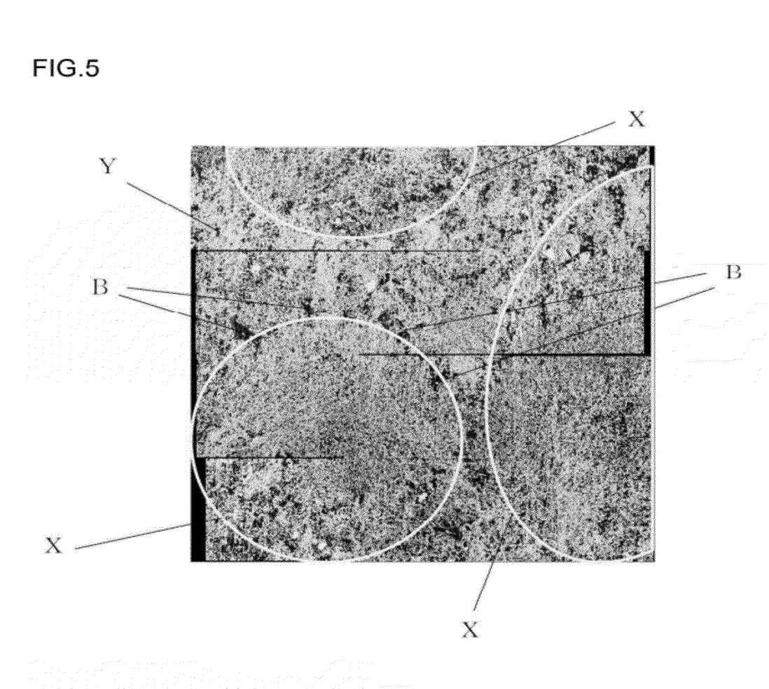

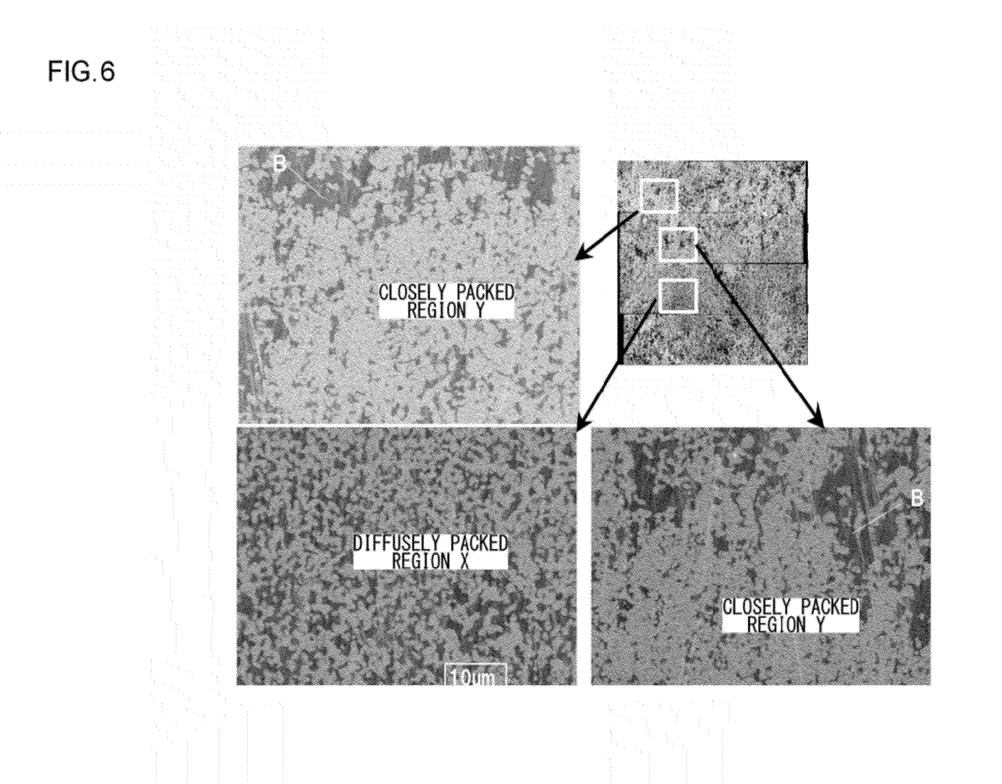

The porous layer thus obtained was subjected to grinding and machining processes to obtain a broken-out surface, and the broken-out surface was prepared by a chemical polishing process. The broken-out surface thus obtained was subjected to a sectional observation using a scanning electron microscope (SEM, 1 kV, 3000-fold magnification). In the SEM observation, a field of view covered a region of about 30×40 μm, and the images of a total of 12 fields of view were taken. The obtained SEM photos were synthesized and digital processing, such as raising the contrast, was performed thereon as appropriate so as to eventually produce an SEM photo of 120 μm×120 μm as shown in FIG. 5. FIG. 6 is the enlargements of the parts of the SEM photo of FIG. 5. As FIG. 5 and FIG. 6 show, the diffusely packed regions X were observed in regions surrounded by relatively large voids (dark parts B), and the closely packed regions were observed as parts whitish around the diffusely packed regions X. Note that the diffusely packed regions are considered to be the coarse parts of the film having the voids (vacancies) intrinsic to the secondary particles.

### Second Embodiment

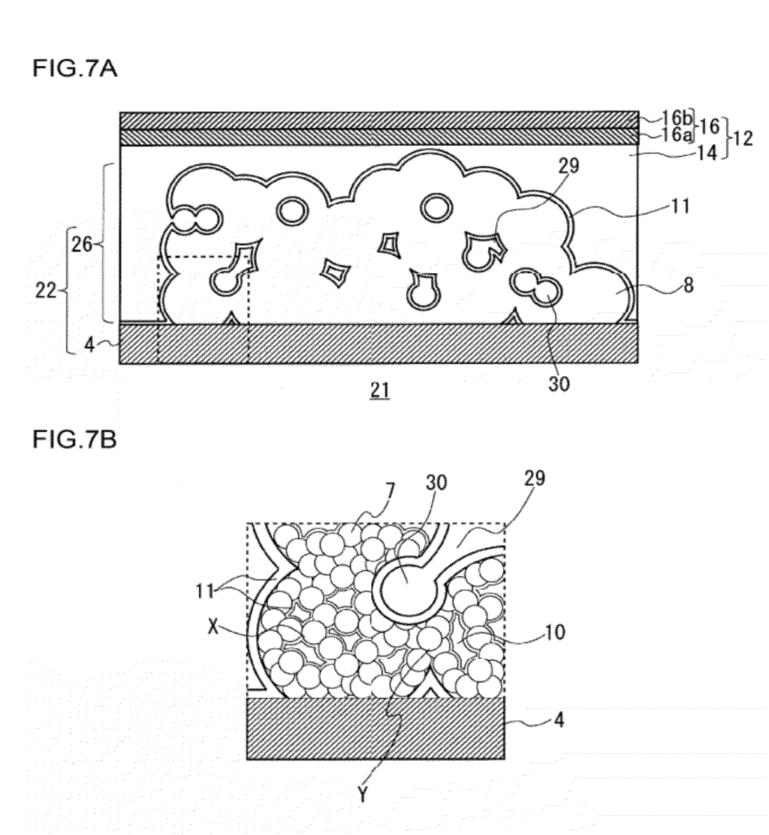

Next, a description is given of a structure of a capacitor 21 and a method for manufacturing the capacitor 21 according to a second embodiment of the present invention, with reference to FIGS. 7A to 9. Note that constituent elements or structural members identical to those of the capacitor 1 according to the first embodiment are given the identical reference numerals to those thereof and the description thereof is omitted.

### Structure of Capacitor 21

FIG. 7A is a schematic cross-sectional view for explaining the structure of the capacitor 21, and FIG. 7B is an enlarged illustration of the region enclosed by a broken line in FIG. 7A.

The capacitor 21 includes an anode body 22, a dielectric layer 11 formed on the surface of the anode body 22, and a cathode body 12 formed on the opposite side of the anode body 22 with the dielectric layer 11 disposed between the dielectric layer 11 and the cathode body 12. The anode body 22 is constituted by an anode substrate 4 and a porous layer 26.

As compared with the porous layer 6, the porous layer 26 is such that, as shown in FIG. 7B, there are formed voids 29, whose size is about 0.01 μm to about 1 μm, and voids 30, whose size is about 1 μm to about 50 μm, in addition to the voids 10 formed amidst the secondary particles 8. Closely packed regions Y are also formed in regions that surround the voids 30, in addition to between the anode substrate 4 and the secondary particle 8 and between the secondary particles 8 themselves. Note here that other structural components of the capacitor 21 are the same as those of the capacitor 1 of the first embodiment, and therefore the description thereof is omitted here.

### Method for Manufacturing Capacitor 1

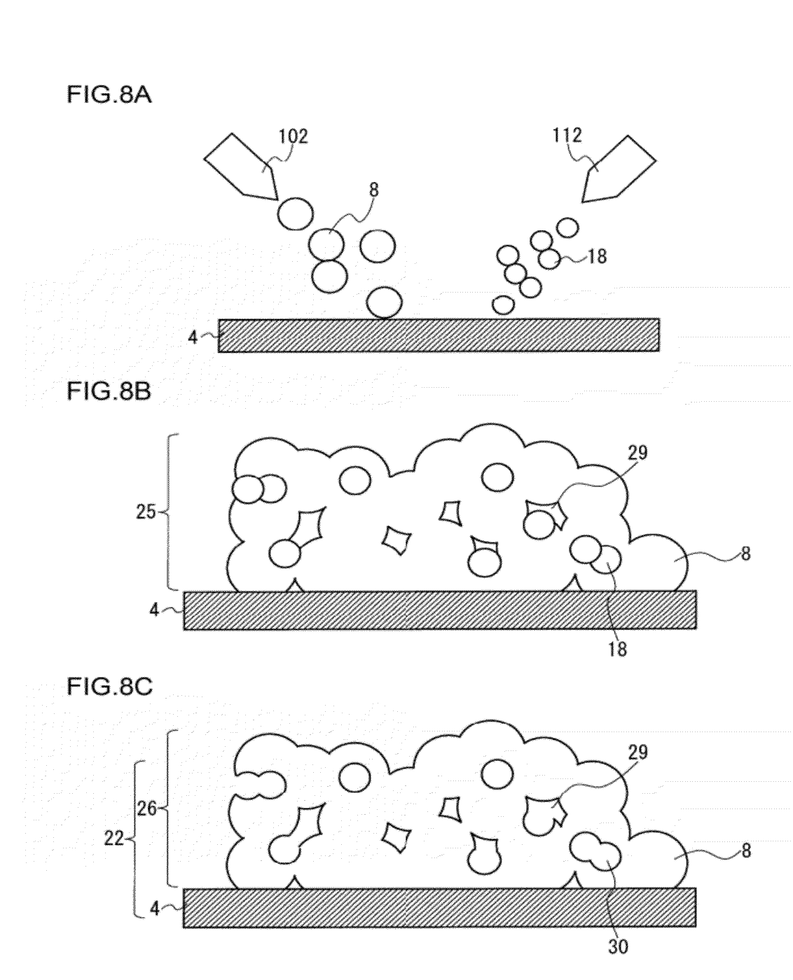

Next, a description will be given of a method for manufacturing a capacitor 21 with reference to FIGS. 8A to 8C. FIGS. 8A to 8C are cross-sectional views for explaining a method for manufacturing an anode body of the capacitor 21.

As shown in FIG. 8A, secondary particles 8, each made up of first metal particles 7 which are Ta, and second metal particles 18, each made up of Cu, are sprayed onto the surface of the anode substrate 4 which is a foil of valve metal Ta.

Here, the second metal particles 18 which are sprayed thereonto is formed of at least one of a metal, whose ionization tendency is greater than that of the first metal particles 7, and an alloy thereof. And each of the second metal particles 18 is of a size ranging from about 1 μm to about 50 μm in diameter. The second metal particles 18 that can be cited include nickel (Ni), iron (Fe), and aluminum (Al) besides the already-mentioned copper (Cu).

The first metal particles 7 and the second metal particles 18 may be combined with each other in various manners. Three of such combinations are as follows, namely the cases (1), (2) and (3), for instance.

(1) When the first metal particles 7 are Ta, the second metal particles 18 are any of Cu, Ni, Al, and Fe.
(2) When the first metal particles 7 are Al, the second metal particles 18 are Cu.
(3) When the first metal particles 7 are Ti, the second metal particles 18 are either Cu or Ni. It is appreciated that each of the second metal particles 18 is of a spherical shape or ellipsoidal shape.

As shown in FIG. 8B, the secondary particles 8 and the second metal particles 18 sprayed onto the anode substrate 4, if they hit the anode substrate 4, attach themselves to the surface of the anode substrate 4. Also, those secondary particles 8 and second metal particle 18 hitting the secondary particles 8 or the second metal particles 18 already attaching to the anode substrate 4 combine themselves with the secondary particles 8 or the second metal particles 18 there to form metal particle clumps. As a result, a composite layer 25, which is constituted by secondary particles 8 and second metal particles 18, is formed on the surface of the anode substrate 4. Retained in the composite layer 25 are voids 10 within each of the secondary particles 8 which have been sprayed onto the anode substrate 4.

At this time, the closely packed regions Y of low voidage, in which the first metal particles 7 making up each of the secondary particles 8 are in close contact with one another, are created between the anode substrate 4 and the secondary particles 8, between the secondary particles 8 and the second metal particles 18, and between the secondary particles themselves by the forces that occur at the collisions of the secondary particles 8. The voidage of the closely packed regions Y becomes lower than the voidage of the diffusely packed regions X formed amidst the secondary particles 8.

Further, as the secondary particles 8 and the second metal particles 18 are sprayed onto the anode substrate 4, voids 29, each measuring about 0.01 μm to about 1 μm, are formed between the secondary particles 8 themselves or between the secondary particles 8 and the second metal particles 18. These voids 29 are created in a manner dependent on the shapes and sizes of the secondary particles 8 and the second metal particles 18 such that the secondary particles 8 are in contact with one another or the secondary particles 8 are in contact with the second metal particles 18.

Then, as shown in FIG. 8C, the second metal particles 18 are eluted in a manner such that the anode substrate 4 on which the composite layer 25 is formed is processed using an acid liquid solution. When the anode substrate 4 is processed using an acid liquid solution, the second metal particles 18, whose ionization tendency is greater than that of the first metal particles 7, are eluted more preferentially than the first metal particles 7. When Cu is used as the second metal particles 18, nitric acid or hot concentrated sulfuric acid may be used here as the acid liquid solution. When Ni, Fe, or Al is used as the second metal particles 18, hydrochloric acid or diluted nitric acid may be used here as the acid liquid solution. It is appreciated that when Al is used as the first metal particles 7 and Cu is used as the second metal particles 18, Cu only can be eluted using a diluted nitric acid.

Thereby, portions where the second metal particles 18 have once been present now become voids 30, whose size is about 1 μm to about 50 μm. As a result, there is formed a porous layer 26, having the voids 10, the voids 29 and the voids 30 on the surface of the anode substrate 4, where the first metal particles 7 within each of the secondary particles 8 are combined with each other in a reticulated (meshy) manner.

There are cases where as result of the spraying of the secondary particles 8 and the second metal particles 18 onto the node substrate 4, an alloy is formed in the joint surfaces between the first metal particles 7 and the second metal particles 18. Since this alloy is formed in a very small region formed in the surface layers of particles, the alloy does not pose any adverse effect on the performance of the capacitor 21 even though the alloy remains there after the second metal particles 18 have been eluted using the acid liquid solution.

In this manner, the node body 22 comprised of the anode substrate 4 and the porous layer 26 is formed by spraying the secondary particles 8 and the second metal particles 18 onto the surface of the anode substrate 4 and then removing the second metal particles 18 only.

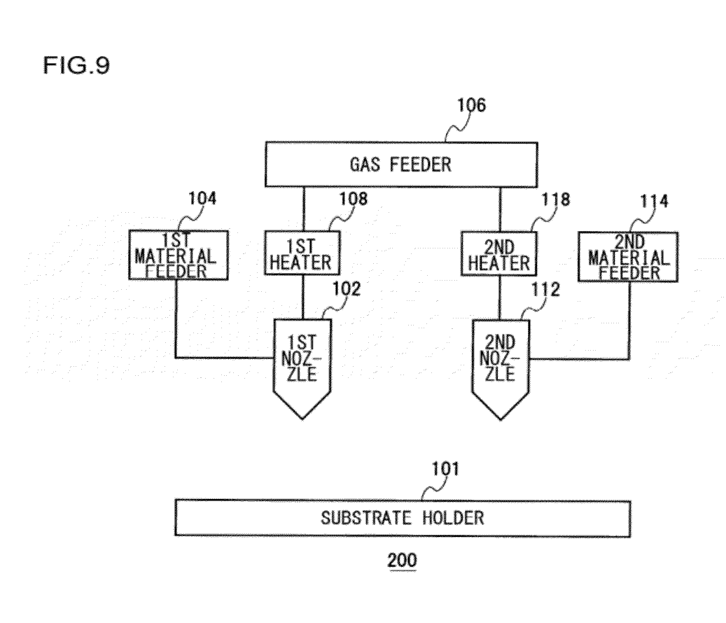

FIG. 9 is a schematic diagram of a cold spray apparatus 200. In addition to the structural components of the cold spray apparatus 100 used in the first embodiment, the cold spray apparatus 200 further includes a second nozzle 112, a second material feeder 114, and a second heater 118.

The second material feeder 114 feeds second metal particles 18 to the second nozzle 112. The gas feeder 106 feeds a pressurized gas to the second nozzle 112 via the second heater 118. The air sent out to the second nozzle 112 from the gas feeder 106 is heated by the second heater 118 before the air is sent to the second nozzle 112. The second metal particles 18 fed to the second nozzle 112 are sprayed from the second nozzle 112 under the pressure of the gas fed from the gas feeder 106.

By the use of the cold spray apparatus 200, the anode substrate 4 can be moved relative to the first nozzle 102 and the second nozzle 112 by the substrate holder 101 while the secondary particles 8 and the second metal particles 18 are sprayed onto the anode substrate 4 from the first nozzle 102 and the second nozzle 112, respectively. Thus, the secondary particles 8 and the second metal particles 18 can be sprayed onto the entire surface of a predetermined region of the anode substrate 4.

It is understood that the voidage of the porous layer 6 can be easily adjusted by adjusting the ratio of the secondary particles 8 and the second metal particles 18 in the composite layer 25. In this case, the ratio of the secondary particles 8 and the second metal particles 18 in the composite layer 25 can be adjusted by adjusting the feed rate of the secondary particles 8 fed from the first material feeder 104 to the first nozzle 102 and the feed rate of the second metal particles 18 fed from the second material feeder 114 to the second nozzle 112.

Hereinafter, similar to the processes as described in conjunction with FIGS. 4A to 4C, the dielectric layer 11 is formed by oxidizing the surface of the anode body 22, and the conductive polymer layer 14 is formed on the dielectric layer 11. Then, the cathode body 16 is stacked on the conductive polymer layer 14 so as to form the cathode body 12. Then, the fabrication of the capacitor 21 is completed by coupling an anode terminal (not shown) to the anode substrate and coupling a cathode terminal (not shown) to the cathode substrate 16.

In summing up the operation and the effect of the structure described above, the method for manufacturing a capacitor electrode body according to the present embodiment is such that the secondary particles 8 and the second metal particles 18 are sprayed onto the anode substrate 4 using a cold spray method and then the second metal particles 18 are removed so as to form the porous anode body 22. Hence, the porous anode body can be easily formed, and the surface area per unit volume of the anode body can be markedly increased.

As a result, a larger capacitance can be realized for the same thickness and a smaller size can be realized for the same capacitance, as compared with the conventional method for manufacturing an electrolytic capacitor as cited in Patent Document 1. As compared with the conventional method for manufacturing an electrolytic capacitor as cited in Non-patent Document 1, an anode body having a very large surface area can be formed, without carrying out the heat treatment process, by simply spraying the secondary particles 8 and the second metal particles 18 using a cold spray method and then eluting the second metal particles 18. Thus, the process of manufacturing the capacitor can be simplified and therefore the capacitors can be manufactured at low cost.

Also, by employing the method for manufacturing a capacitor electrode body according to the present embodiment, the composite layer 25 having the voids 10 and the voids 29 are formed by spraying the secondary particles 8, having the voids 10, and the second metal particles 18 onto the anode substrate 4. In contrast to this, in the method as cited in Non-patent Document 1, a Ta—Cu alloy film is formed by sputtering microparticles and therefore there are only lattice-defect-level spaces amidst the particles. This indicates that there are almost no voids amidst the particles.

Thus, in the present embodiment, the liquid solution used to dissolve the second metal particles 18 is more likely to reach the second metal particles 18 located in an inner deep part away from the surface layer of the composite layer 25 via the voids 10 and the voids 29. Hence, the second metal particles 18 deep within the composite layer 25 can be easily eluted. As a result, the surface area of the anode body 22 can be made large and therefore the capacitor 21 can be made markedly larger. Further, the second metal particles 18 in the inner deep part can be eluted even though the film thickness of the composite layer 25 is made thicker, so that the anode body 22 can be made thicker.

Also, by employing the method for manufacturing a capacitor electrode body according to the present embodiment, the voids 30, whose size is about 1 μm to about 50 μm, are formed in the porous layer 26 of the anode body 22 in addition to the voids 10 and the voids 29 whose size are about 0.01 μm to about 1 μm. It is highly probable that both the voids 10 and the voids 29 of smaller size may become closed spaces which are surrounded by the first metal particles 7. However, the formation of the voids 30 of larger size significantly reduces the chance that the voids 10 and the voids 29 will become closed spaces. Accordingly, the conductive polymer layer 14 can be formed in most of the voids 10, the voids 29 and the voids 30 in the porous layer 26. As a result, the area of the anode body 22 in contact with the conductive polymer layer 14 through the dielectric layer 11 increases, so that the capacitance derivation rate can be raised. Further, the volume of the conductive polymer layer 14 wrapping around or sneaking into the anode body 22 increases, so that the ESR of the capacitor 21 can be lowered.

Also, by employing the method for manufacturing a capacitor electrode body according to the present embodiment, the porous layer 26 is formed in such a manner that a force like a pressing force is applied and distributed among the first metal particles 7. Accordingly, a force by which to restore the state, where the first metal particles 7 have been pressed against each other, to the original state acts on the anode substrate 4 where the porous layer 26 is formed. In other words, the force acts on the anode substrate 4 in a direction where the surface on which the porous layer 26 is formed is rolled back in a protruding manner. However, since the voids 10, the voids 29 and the voids 30 are formed in the porous layer 26, the stress can be damped by the voids 10, the voids 29 and the voids 30 as compared with the case where there is no voids amidst the particles. As a result, the breakage and the like of the capacitor 21 can be prevented and therefore the reliability of the capacitor 21 can be enhanced.

Other advantageous effects of the present embodiment are identical to those of the first embodiment. It is to be noted here that according to the capacitor 21 of the present embodiment, the closely packed regions Y are formed around the voids 30 as well and therefore the resistance of the anode body 22 can be more reduced than in the capacitor 1 of the first embodiment.

### Third Embodiment

In the method for manufacturing an electrolytic capacitor as cited in Patent Document 1, there is a limit in thinning the anode body to achieve a lower height thereof while retaining an adequate surface area for a larger capacitance of the capacitor. That is, to form the pressed powders of a valve metal, an aggregate of powders needs to have a certain thickness. Also, when the powders of the valve metal are press-formed under higher pressure to achieve a lower height of the capacitor, there is a problem of a decreased surface area of the anode body because the voids amidst the particles are clogged up.

Also, in the method for manufacturing an electrolytic capacitor as cited in Non-patent Document 1, the Ta—Cu alloy film is formed using very fine particles of Ta and Cu. Thus, there is a problem where an adequate surface area of the anode body cannot be maintained unless the Cu particles are eluted after the grain growth of the Ta and Cu particles by the heat treatment. A third embodiment of the present invention has been made in view of such problems.

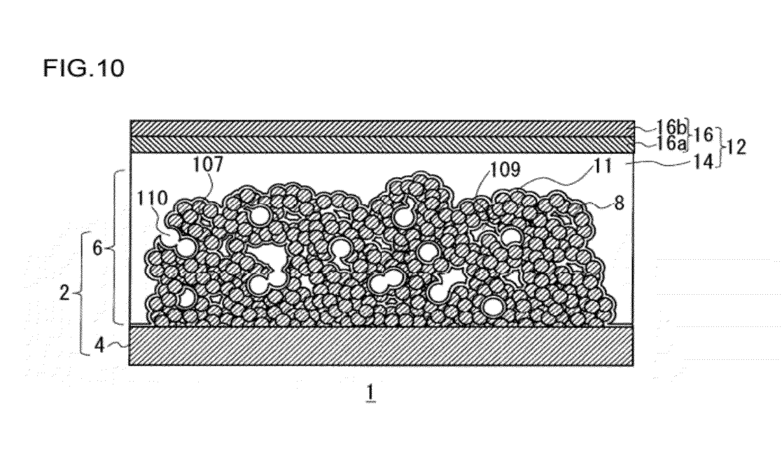

A description is now given of a method for manufacturing a capacitor according to the third embodiment of the present invention and a capacitor 1 manufactured by this method with reference to FIGS. 10 to 12C. Constituent elements or structural members of the third embodiment identical to those of the capacitor 1 according to the first embodiment are given the identical reference numerals to those thereof and the description thereof is omitted as appropriate.

### Structure of Capacitor 1

FIG. 10 is a schematic cross-sectional view showing the structure of the capacitor 1.

The capacitor 1 includes an anode body 2, a dielectric layer 11 formed on the surface of the anode body 2, and a cathode body 12 formed on the opposite side of the anode body 2 with the dielectric layer 11 disposed between the dielectric layer 11 and the anode body 2.

A porous layer 6 is a layer formed of metal particle clumps which are a combination of a plurality of first metal particles 7 which comprise at least one of the valve metal and the alloy thereof. The first metal particles 7 are each a particle whose diameter is about 1 μm or less. Amidst the first metal particles 7, there are formed voids 107 and 109, each measuring about 0.01 μm to about 1 μm, and voids 110, measuring about 1 μm to about 50 μm. Thus, the combined first metal particles 7 form a net-like network.

The conductive polymer layer 14 is formed in a predetermined thickness in such a manner as to cover the surface of the dielectric layer 11, that is, to bury the voids 107, the voids 109 and the voids 110 of the anode body 2.

### Method for Manufacturing a Capacitor 1

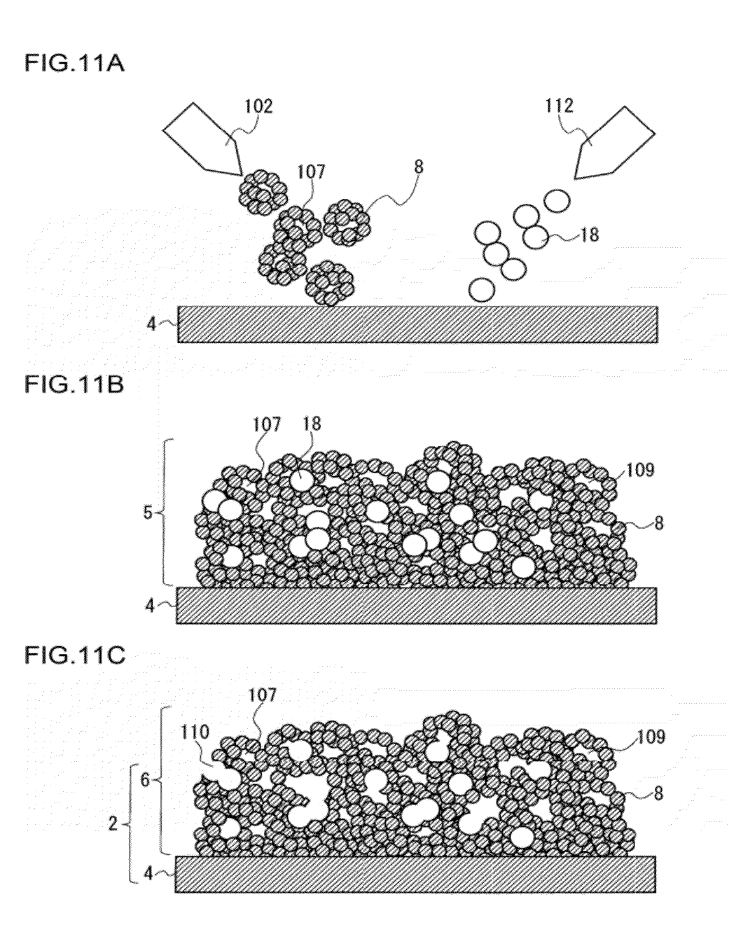

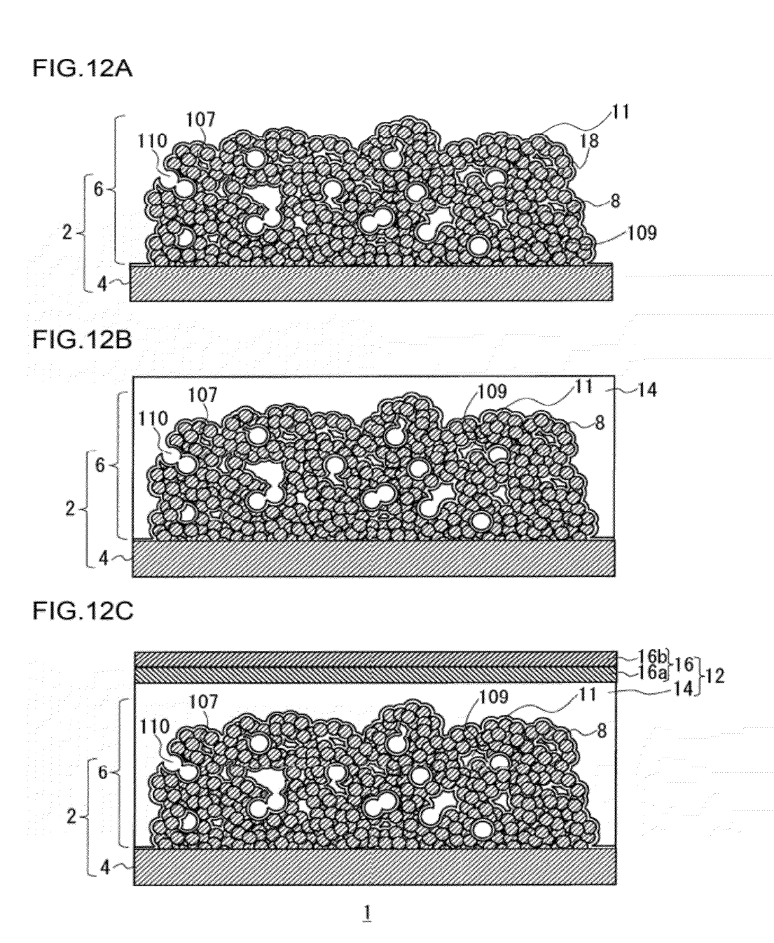

Next, a description will be given of a method for manufacturing a capacitor 1 with reference to FIGS. 11A to 12C. FIGS. 11A to 11c are cross-sectional views for explaining a method for manufacturing an anode body of the capacitor 1.

As shown in FIG. 11A, first metal particles 7, each made up of Ta, and second metal particles 18, each made up of Cu, are sprayed onto the surface of the anode substrate 4 which is a foil of valve metal Ta.

Here, the first metal particles 7 which are to be sprayed onto the surface thereof are each a porous aggregate measuring about 10 μm to about 100 μm in size, which is formed by assembling a plurality of the first metal particles 7. This aggregate has voids 107, whose size is about 0.01 μm to about 1 μm, amongst the first metal particles 7. These voids 107 are created in a manner dependent on the diameters of the first metal particles 7 in contact with one another.

As shown in FIG. 11B, the first metal particles 7 and the second metal particles 18 sprayed onto the anode substrate 4, if they hit the anode substrate 4, attach themselves to the surface of the anode substrate 4. Also, those first metal particles 7 and second metal particle 18 hitting the first metal particles 7 or the second metal particles 18 already attaching to the anode substrate 4 combine themselves with the first metal particles 7 or the second metal particles 18 there to form metal particle clumps.

As a result, a composite layer 5, which is constituted by first metal particles 7 and second metal particles 18, is formed on the surface of the anode substrate 4. Retained in the composite layer 5 are voids 107 in the aggregate of first metal particles 7 which have been sprayed onto the anode substrate 4. Also, by spraying the aggregate of first metal particles 7 and the second metal particles 18 onto the anode substrate 4, the voids 109, each measuring about 0.01 μm to about 1 μm, are formed in between an aggregate of first metal particles 7 and another aggregate thereof or between the aggregate of first metal particles 7 and the second metal particles 18, in the composite layer 5. These voids 109 are created in a manner dependent on the diameters of the first metal particles 7 and the second metal particles 18 such that the first metal particles 7 are in contact with one another or the first metal particles 7 are in contact with the second metal particles 18.

Then, as shown in FIG. 11C, the second metal particles 18 are eluted in a manner such that the anode substrate 4 on which the composite layer 5 is formed is processed using an acid liquid solution. When the anode substrate 4 is processed using an acid liquid solution, the second metal particles 18, whose ionization tendency is greater than that of the first metal particles 7, are eluted more preferentially than the first metal particles 7.

Thereby, portions where the second metal particles 18 have once been present now become voids 110, whose size is about 1 μm to about 50 μm. As a result, there is formed a porous layer 6, having the voids 107, the voids 109 and the voids 110 on the surface of the anode substrate 4, where the first metal particles 7 are combined with each other in a reticulated (meshy) manner.

In this manner, the node body 22 comprised of the anode substrate 4 and the porous layer 6 is formed by spraying the first metal particles 7 and the second metal particles 18 onto the surface of the anode substrate 4 and then removing the second metal particles 18 only.

Here, a cold spray method is used preferably as a method for spraying first metal particles 7 and second particles onto the anode substrate 4. When the cold spray method is used, a composite layer 5 can be formed which has high adhesion strength between the anode substrate 4 and the first metal particles 7, between the anode substrate 4 and the second metal particles 18, between the first metal particles 7 themselves, between the second metal particles 18 themselves, and between the first metal particles 7 and the second metal particles 18.

By the use of the cold spray apparatus 200 as shown in FIG. 9, the anode substrate 4 can be moved relative to the first nozzle 102 and the second nozzle 112 by the substrate holder 101 while the first metal particles 7 and the second metal particles 18 are sprayed onto the anode substrate 4 from the first nozzle 102 and the second nozzle 112, respectively. Thus, the first metal particles 7 and the second metal particles 18 can be sprayed onto the entire surface of a predetermined region of the anode substrate 4.

It is understood that the voidage (porosity) of the porous layer 6 can be easily adjusted by making adjustments to the ratio of the first metal particles 7 and the second metal particles 18 in the composite layer 5. In this case, the ratio of the first metal particles 7 and the second metal particles 18 in the composite layer 5 can be adjusted by adjusting the feed rate of the first metal particles 7 fed from the first material feeder 104 to the first nozzle 102 and the feed rate of the second metal particles 18 fed from the second material feeder 114 to the second nozzle 112.

Also, the voidage of the porous layer 6 can be adjusted by making adjustments to the sizes of first metal particles 7 and secondary particles 8, the spray speed (sprayed gas pressure) from each nozzle, the sprayed gas temperature, and the like. For example, the choice of smaller sizes for the first metal particles 7 and lower spray speed of the particles will create a porous layer 6 of greater porosity. Also, the choice of a lower sprayed gas temperature may create a porous layer 6 of greater porosity.

Besides the above-described mercury intrusion technique, the voidage of the porous layer 6 can be calculated as follows, for instance. That is, a region containing about 100 pieces of first metal particles 7 is defined in a sectional image or the like of the porous layer 6 captured by a transmission electron microscope (TEM) or the like. Then the voidage of the porous layer 6 can be calculated from the area ratio between the part of the first metal particles 7 including the dielectric layers 11 of the defined region and the other part thereof, namely, the voids 107, the voids 109 and the voids 110 (the part of the conductive polymer layer 14 of a completed capacitor 1).

Next, a description will be given of a method for manufacturing a cathode body of the capacitor 1 with reference to FIGS. 12A to 12C. FIGS. 12A to 12C are cross-sectional views for explaining a method for manufacturing a cathode body of the capacitor 1.

As shown in FIG. 12A, a dielectric layer 11 is formed by oxidizing the surface of an anode body 2. Since the anode substrate 4 and the first metal particles 7 are made of Ta, the dielectric layer 11 is an oxide film composed of tantalum oxide (Ta₂O₅). In the present embodiment, the dielectric layer 11 is formed by performing the electrolytic formation process on the anode body 2. More specifically, the anode body 2 is subjected to an anodic oxidation at constant voltage in an electrolyte of 0.01 to 1.0 mass % phosphoric acid aqueous solution, thereby forming an oxide film of tantalum oxide on the surface thereof. Thus, the dielectric layer 11 is formed on the exposed surfaces of the anode substrate 4 and the surfaces of metal clumps formed by combining the first metal particles 7 combined.

Then, as shown in FIG. 12B, a conductive polymer layer 14 is formed by a chemical oxidative polymerization in such a manner as to cover the surface of the dielectric layer 11, that is, to bury the voids 107, the voids 109 and the voids 110 in the anode body 2.

Next, as shown in FIG. 12C, a carbon paste layer 16a and a silver paste layer 16b, in this order, are stacked on top of the conductive polymer layer 14, thereby forming a cathode substrate 16. In this manner, a cathode body 12, which includes the conductive polymer layer 14 and the cathode substrate 16, is formed.

Then a capacitor 1 can be fabricated by coupling an anode terminal (not shown) to the anode substrate 4 via a conductive adhesive, for instance, and coupling a cathode terminal (not shown) to the cathode substrate 16 via a conductive adhesive, for instance.

In summing up the operation and the effect of the structure described above, the method for manufacturing a capacitor electrode body according to the present embodiment is such that the first metal particles 7 and the second metal particles 18 are sprayed onto the anode substrate 4 using a cold spray method and then the second metal particles 18 are removed so as to form the porous anode body 2. Hence, the porous anode body can be easily formed, and the surface area per unit volume of the anode body can be markedly increased.

As a result, a larger capacitance can be realized for the same thickness and a smaller size can be realized for the same capacitance, as compared with the conventional method for manufacturing an electrolytic capacitor as cited in Patent Document 1. As compared with the conventional method for manufacturing an electrolytic capacitor as cited in Non-patent Document 1, an anode body having a very large surface area can be formed, without carrying out the heat treatment process, by simply spraying the first metal particles 7 and the second metal particles 18 using a cold spray method and then eluting the second metal particles 18. Thus, the process of manufacturing the capacitor can be simplified and therefore the capacitors can be manufactured at low cost.

Also, by employing the method for manufacturing a capacitor electrode body according to the present embodiment, the composite layer 25 having the voids 107 and the voids 109 are formed by spraying an aggregate of first metal particles 7 and the secondary particles 8, having the voids 107, and the second metal particles 18 onto the anode substrate 4. In contrast to this, in the method as cited in Non-patent Document 1, a Ta—Cu alloy film is formed by sputtering microparticles and therefore there are only lattice-defect-level spaces amidst the particles. This indicates that there are almost no voids amidst the particles.

Thus, in the present embodiment, the liquid solution used to dissolve the second metal particles 18 is more likely to reach the second metal particles 18 located in an inner deep part away from the surface layer of the composite layer 5 via the voids 107 and the voids 109. Hence, the second metal particles 18 deep within the composite layer 5 can be easily eluted. As a result, the surface area of the anode body 2 can be made large and therefore the capacitor 1 can be made markedly larger. Further, the second metal particles 18 in the inner deep part can be eluted even though the film thickness of the composite layer 5 is made thicker, so that the anode body 2 can be made thicker.

Also, by employing the method for manufacturing a capacitor electrode body according to the present embodiment, the voids 110, whose size is about 1 μm to about 50 μm, are formed in the porous layer 6 of the anode body 2 in addition to the voids 107 and the voids 109 whose size are about 0.01 μm to about 1 μm. It is highly probable that both the voids 107 and the voids 109 of smaller size may become closed spaces which are surrounded by the first metal particles 7. However, the formation of the voids 110 of larger size significantly reduces the chance that the voids 107 and the voids 109 will become closed spaces. Accordingly, the conductive polymer layer 14 can be formed in most of the voids 107, the voids 109 and the voids 110 in the porous layer 6. As a result, the area of the anode body 2 in contact with the conductive polymer layer 14 through the dielectric layer 11 increases, so that the capacitance derivation rate can be raised. Further, the volume of the conductive polymer layer 14 wrapping around or sneaking into the anode body 2 increases, so that the ESR of the capacitor 1 can be lowered.

Also, according to the present embodiment, it is not necessary to perform a firing or other heat treatment processes after the formation of the porous layer 6, unlike the method disclosed in Patent Document 1. Thus, the voids 107 and voids 109 in the porous layer 6 can be prevented from getting smaller in size (diameter) on account of the heat treatment process. As a result, the present embodiment can prevent the reduction in the area of the anode body 2 in contact with the conductive polymer layer 14 through the dielectric layer 11 and in the volume of the conductive polymer layer 14 wrapping around or sneaking into the anode body 2. And this will not only raise the capacitance derivation rate but also realize lowered ESR for the capacitor 1.

Also, by employing the method for manufacturing a capacitor electrode body according to the present embodiment, the porous layer 6 is formed in such a manner that a force like a pressing force is applied and distributed among the first metal particles 7. Accordingly, a force by which to restore the state, where the first metal particles 7 have been pressed against each other, to the original state acts on the anode substrate 4 where the porous layer 6 is formed. In other words, the force acts on the anode substrate 4 in a direction where the surface on which the porous layer 6 is formed is rolled back in a protruding manner. However, since the voids 107, the voids 109 and the voids 110 are formed in the porous layer 6, the stress can be damped by the voids 107, the voids 109 and the voids 110 as compared with the case where there is no void amidst the particles. As a result, the breakage and the like of the capacitor 1 can be prevented and therefore the reliability of the capacitor 1 can be enhanced.

The present invention is not limited to the above-described embodiments only. It is understood that various modifications such as changes in design may be made based on the knowledge of those skilled in the art, and the embodiments added with such modifications are also within the scope of the present invention.

For example, according to the first and second embodiments, the closely packed regions Y of low voidage are formed between the anode substrate 4 and the secondary particle 8 and between the secondary particles 8 themselves. However, preferred embodiments are not limited thereto and it suffices if the closely packet regions Y are formed at least partially between the anode substrate 4 and the secondary particle 8 and between the secondary particles 8 themselves. Forming the closely packed regions Y in at least part of the porous layer 6 allows the resistance of the anode body 2 to be further reduced as compared with the conventional electrolytic capacitor. Thus, the ESR of the capacitor 1 can be lowered.

In such case, it is preferable particularly in the second embodiment that the closely packed regions Y are formed at least partially between the anode substrate 4 and the secondary particles 8, between the secondary particles 8 and the second metal particles 18, and between the secondary particles 8 themselves.

In the above-described embodiments, the porous anode body is formed using a cold spray method. However, the anode body may be formed by the use of a technique including a known aerosol deposition method and a powder jet method in which the film is formed by spraying unmelted particles at high speed. Such methods can be employed to form the porous anode body.

Although, in the above-described embodiments, the cold spray method is performed in the air, the cold spray method may be performed in a vacuum chamber, instead.

Although, in the above-described embodiments, the Ta foil is used as the anode substrate 4, a substance or material having a membrane-like structure where a plurality of first metal particles 7 are combined together may be used as the anode substrate 4, instead. In such a case, the anode substrate 4 may be formed as follows. That is, a film of first metal particles 7 is formed on the surface of the material by spraying the first metal particles 7 onto a plate member using the cold spray method and then removing the plate member. Thereby, the anode substrate 4 made of the first metal particles 7 can be formed.

Although, in the second and third embodiments, the second metal particles 18 are eluted using an acid liquid solution, the second metal particles 18 may be etched using an RIE apparatus.

In the second and third embodiments, a material made of at least one of a metal, whose ionization tendency is greater than that of the first metal particles 7, and an alloy thereof is used as the second metal particles 18. However, any other material may be used for the second metal particles 18 as long as it dissolves more preferentially relative to a predetermined liquid solution than the first metal particles 7.

When, in the second embodiment, the secondary particles 8 and the second metal particles 18 are sprayed onto the anode substrate 4 using the cold spray apparatus 200, the spraying of the secondary particles 8 from the first nozzle 102 and the spraying of the second metal particles 18 from the second nozzle 112 may be done simultaneously. Thereby, the time period required for the process of manufacturing the capacitor electrode body can be reduced.

In the second embodiment, the spraying of the secondary particles 8 and the spraying of the second metal particles 18 may be done alternately. According to this modification, the ratio of the secondary particles 8 and the second metal particles 18 is freely adjustable depending on the location.

Moreover, in the second embodiment, the secondary particles 8 and the second metal particles 18 may be mixed together in advance and the thus mixed particles may be sprayed from the same nozzle. According to this modification, the structure of the cold spray apparatus can be simplified, so that the manufacturing cost of the capacitors 21 can be reduced.

In the third embodiment, an aggregate formed by assembling a plurality of the first metal particles 7 is sprayed onto the anode substrate 4. However, a single particle in the first metal particles 7 may be sprayed each time. Although the voids 107 are formed in the aggregate of first metal particles 7, the voids 107 may not be formed at all.

When, in the third embodiment, the first metal particles 7 and the second metal particles 18 are sprayed onto the anode substrate 4 using the cold spray apparatus 200, the spraying of the first metal particles 7 from the first nozzle 102 and the spraying of the second metal particles 18 from the second nozzle 112 may be done simultaneously. Thereby, the time period required for the process of manufacturing the capacitor electrode body can be reduced.

In the third embodiment, the spraying of the first metal particles 7 and the spraying of the second metal particles 18 may be done alternately. According to this modification, the ratio of the first metal particles 7 and the second metal particles 18 is freely adjustable depending on the location.

Moreover, in the third embodiment, the first metal particles 7 and the second metal particles 18 may be mixed together in advance and the thus mixed particles may be sprayed from the same nozzle. According to this modification, the structure of the cold spray apparatus can be simplified, so that the manufacturing cost of the capacitors 21 can be reduced.

In the second and third embodiments, not only the first metal particles 7 but also the second metal particles 18 made of Cu are sprayed onto the surface of the anode substrate 4. Insulating particles such as SiO₂ and ZiO₂ may be used as substitute for the second metal particles 18. Where SiO₂ or ZiO₂ is used as the insulating particles, the insulating particles alone can be eluted if the first metal particles 7 and the insulating particles are formed on the surface of the anode substrate 4 and then processed using solution such as hydrofluoric acid and ammonium fluoride.

### DESCRIPTION OF THE REFERENCE NUMERALS

1, 21 Capacitor
2, 22 Anode body
4 Anode substrate
5, 25 Composite body
6, 26 Porous layer
7 First metal particles
8 Secondary particles
9, 10, 29, 30 Void
11 Dielectric layer
12 Cathode body
14 Conductive polymer layer
16 Cathode substrate
16a Carbon paste layer
16b Silver paste layer
18 Second metal particles
100, 200 Cold spray apparatus
101 Substrate holder
102 First nozzle
104 First material feeder
106 Gas feeder
108 First heater
112 Second nozzle
114 Second material feeder
118 Second heater
107, 109, 110 Void

### INDUSTRIAL APPLICABILITY

The present invention relates to a method for manufacturing a capacitor electrode body and a method for manufacturing a capacitor.

1. A capacitor electrode body, comprising:
a substrate made of at least one of a valve metal and an alloy thereof; and
a porous layer disposed on said substrate, the porous layer being formed of a combination of a plurality of first metal particles composed of at least one of the valve metal and the alloy thereof,
wherein said porous layer includes a first region and a second region, the second region being so formed as to surround the first region and having a lower porosity than the first region.

2. A capacitor electrode body according to claim 1, wherein said porous layer is formed of a combination of a plurality of secondary particles composed of the first metal particles, and
wherein the first metal particles constituting each of the secondary particles are in closer contact with each other in the second region than in the first region.

3. A capacitor electrode body according to claim 1, wherein said porous layer is formed of a combination of a plurality of secondary particles composed of the first metal particles, and
wherein the first region is formed within the secondary particles.

4. A capacitor electrode body according to claim 3, wherein the second region is formed between adjacent first regions of the secondary particles.

5. A capacitor electrode body according to claim 3, wherein the second region is formed between said substrate and the first region.

6. A capacitor, comprising:
an anode body comprising a capacitor electrode body according to claim 1;
an dielectric layer formed on a surface of said anode body; and
a cathode body formed such that said cathode body covers the surface of said dielectric layer.

7. A method for manufacturing a capacitor electrode body, the method including a porous layer manufacturing process of forming a porous layer by spraying secondary particles composed of first metal particles made of at least one of a valve metal and an alloy thereof onto a substrate made of at least one of a valve metal and an alloy thereof in a manner such that
a first region and a second region are formed, the second region being so formed as to surround the first region and having a lower porosity than the first region.

8. A method, for manufacturing a capacitor electrode body, according to claim 7, wherein the first metal particles constituting each of the second particles are in closer contact with each other in the second region than in the first region.

9. A method, for manufacturing a capacitor electrode body, according to claim 7, wherein the porous layer is formed of a combination of a plurality of secondary particles formed of the first metal particles, and
the first region is formed within the secondary particles.

10. A method, for manufacturing a capacitor electrode body, according to claim 9, wherein the second region is formed between the substrate and the first region.

11. A method, for manufacturing a capacitor electrode body, according to claim 7, wherein said porous layer manufacturing process includes:
a first process of forming a composite body by spraying second metal particles, which are preferentially removed over the first metal particles, through a predetermined processing; and
a second process of removing the second metal particles from the composite body through the predetermined processing, and forming the porous layer.

12. A method for manufacturing a capacitor electrode body, the method including:
a process of preparing a capacitor electrode body, formed by employing a manufacturing method according to any one of claim 7 to claim 11, as an anode body;
a dielectric layer forming process of forming a dielectric layer by oxidizing a surface of the anode body; and
a cathode body forming process of forming a cathode body in such a manner as to cover a surface of the dielectric layer.

13. A method for manufacturing a capacitor electrode body, the method including:
a first process of forming a composite body by spraying first metal particles made of at least one of a valve metal and an alloy thereof and second metal particles, which are preferentially removed over the first metal particles through a predetermined processing, onto a substrate made of at least one of a valve metal and an alloy thereof in a manner such that
a first void has void in between each particle; and
a second process of removing the second metal particles from the composite body through the predetermined processing.

14. A method, for manufacturing a capacitor electrode body, according to claim 13, wherein the first void is created such that the first metal particle comes in contact with the second metal particle.

15. A method, for manufacturing a capacitor electrode body, according to claim 13, wherein the second metal particle is made of a material that dissolves more preferentially relative to a predetermined liquid solution than the first metal particle, and
wherein, in said second process, the second metal particles are eluted from the composite body by processing the composite body using the predetermined liquid solution.

16. A method, for manufacturing a capacitor electrode body, according to claim 13, wherein the second metal particle is made of at least one of a metal, whose ionization tendency is greater than that of the first metal particle, and an alloy thereof.

17. A method, for manufacturing a capacitor electrode body, according to claim 13, wherein, in said first process, the first metal particles are sprayed onto the substrate as an aggregate formed by assembling a plurality of the first metal particles, and
wherein the aggregate thereof is porous particles formed in a second void formed in between each of the first metal particles.

18. A method, of manufacturing a capacitor electrode body, according to claim 17, wherein the second void is created such that the first metal particles come in contact with each other.

19. A method of manufacturing a capacitor electrode body, the method including:
a process of preparing a capacitor electrode body, formed by employing a manufacturing method according to any one of claim 13 to claim 18, as an anode body;
a dielectric layer forming process of forming a dielectric layer by oxidizing a surface of the anode body; and
a cathode body forming process of forming a cathode body in such a manner as to cover a surface of the dielectric layer.
